(19) United States
(12) Patent Application Publication
(10) Pub. No.: US 2026/0018354 A1
(43) Pub. Date: Jan. 15, 2026

(54) METHOD OF CONTROLLING CONTACTOR, CONTACTOR SYSTEM, PROGRAM PRODUCT AND STORAGE MEDIUM

(71) Applicant: Schneider Electric Industries SAS, Rueil Malmaison (FR)

(72) Inventors: Hao ZHUANG, Shanghai (CN); Jiaying CHEN, Shanghai (CN); Meng DU, Shanghai (CN); Zhe LI, Shanghai (CN); Xiaole ZHOU, Shanghai (CN); Yuanzhong WANG, Shanghai (CN); Heling LI, Shanghai (CN); Tianming JI, Shanghai (CN); Danyu LIU, Shanghai (CN); Yuwen WANG, Shanghai (CN)

(21) Appl. No.: 19/263,114

(22) Filed: Jul. 8, 2025

(30) Foreign Application Priority Data
Jul. 10, 2024 (CN) 202410921143.X

(51) Int. Cl. H01H 47/00

(52) U.S. Cl. CPC H01H 47/002

(57) ABSTRACT

The present disclosure relates to a method for controlling a contactor, wherein power is supplied to the contactor by a power supply external to the contactor. The method includes: in response to determining that a power supply voltage of the power supply is greater than a first voltage threshold, determining whether an abnormal current drop process occurs; and in response to determining that the abnormal current drop process occurs, controlling a first power supply time, during which a first power supply voltage for the contactor is supplied, to be extended from a preset first value to a second value, wherein the abnormal current drop process indicates that the contactor fails to attract as expected. The present disclosure also relates to a contactor system, a computer program product and a computer-readable storage medium.

### TECHNICAL FIELD

The present disclosure relates to the field of contactor control, and in particular to a method for controlling a contactor, a contactor system, a computer program product and a computer-readable storage medium.

### BACKGROUND

A contactor is a widely used switching appliance used to switch on, switch off, and control current in an electrical circuit. A contactor is an important power distribution component, and it is of great research and application value to control contactor flexibly and accurately.

### SUMMARY

Embodiments of the present disclosure provide a method, a contactor system, a computer program product and a computer-readable storage medium for controlling a contactor. By judging in advance whether the contactor can be stably attracted under the current power supply voltage, it is possible to extend the power supply time in a timely manner, and it can ensure the stable attraction of the contactor in a non-ideal working environment without changing the power supply voltage or redesigning and replacing the contactor. At the same time, it achieves timeliness, high flexibility and low cost, and reduces the power consumption of the contactor.

Embodiments of the present disclosure provide a method for controlling a contactor, wherein the contactor is powered by a power supply external to the contactor. The method comprises: in response to determining that a power supply voltage of the power supply is greater than a first voltage threshold, determining whether an abnormal current drop process occurs; and in response to determining that the abnormal current drop process occurs, controlling a first power supply time, during which a first power supply voltage for the contactor is supplied, to be extended from a preset first value to a second value, wherein the abnormal current drop process indicates that the contactor fails to attract as expected.

According to an embodiment of the present disclosure, the method further comprises controlling the first power supply time to be extended from the first value to a third value in response to determining that the power supply voltage is greater than an attraction voltage and less than or equal to the first voltage threshold.

According to an embodiment of the present disclosure, the determining whether the abnormal current drop occurs comprises: determining a first duration, the first duration being a duration between a first time point when a coil voltage of a coil of the contactor reaches the attraction voltage and a second time point when a coil current of the coil of the contactor decreases to a first current threshold, wherein the abnormal current drop is determined to occur based on the first duration being greater than a first duration threshold.

According to an embodiment of the present disclosure, the first current threshold is a preset percentage of an attraction current of the contactor.

According to an embodiment of the present disclosure, the determining whether the abnormal current drop process occurs comprises: determining a similarity of the current change curve with a reference current change curve in a second duration; and determining that the abnormal current drop process occurs based on the similarity being less than a similarity threshold.

According to an embodiment of the present disclosure, the similarity is determined based on Euclidean distances and/or Manhattan distances and/or a mean absolute error between the current change curve and the reference current change curve in the second duration and/or using a deep learning approach.

According to an embodiment of the present disclosure, the method further comprises: after reaching the first power supply time, controlling the contactor not to be powered; and in response to a coil current of the coil of the contactor decreasing to an attraction holding current, controlling to provide a second power supply voltage smaller than the first power supply voltage for the contactor.

Embodiments of the present disclosure provide a contactor system, comprising: a contactor; one or more processors; and one or more memories having stored therein computer-executable programs that, when executed by the one or more processors, perform the method according to one of the embodiments of the present disclosure.

Embodiments of the present disclosure provide a computer program product, comprising computer instructions for implementing the method according to one of the embodiments of the present disclosure when executed by a processor.

Embodiments of the present disclosure provide a computer-readable storage medium having computer-executable instructions stored thereon, which when executed by a processor, implement the method according to one of the embodiments of the present disclosure.

### BRIEF DESCRIPTION OF DRAWINGS

In order to explain the technical solutions of the embodiments of the present disclosure more clearly, the drawings needed to be used in the description of the embodiments will be briefly introduced below. Obviously, the drawings in the following description are only some exemplary embodiments of the present disclosure. For those of ordinary skill in the art, other drawings can be obtained based on these drawings without exerting creative efforts.

FIG. 1 exemplarily shows a schematic diagram of a current change curve during the attraction process of a contactor according to an embodiment of the present disclosure;

FIG. 2 exemplarily shows a schematic diagram of an abnormal current drop process during an attraction process of a contactor;

FIG. 3 shows a schematic flow diagram of steps of a method for controlling a contactor according to an embodiment of the present disclosure;

FIGS. 4a and 4b respectively show a schematic diagram of a process of determining an abnormal current drop according to an embodiment of the present disclosure;

FIG. 5 shows a schematic diagram of a contactor system according to an embodiment of the present disclosure;

FIG. 6 shows a schematic diagram of a computer program product according to an embodiment of the present disclosure; and

FIG. 7 shows a schematic diagram of a computer-readable storage medium according to an embodiment of the present disclosure.

### DETAILED DESCRIPTION

In order to make the purpose, technical solutions and advantages of the present disclosure more obvious, example embodiments according to the present disclosure will be described in detail below with reference to the accompanying drawings. Obviously, the described embodiments are only some of the embodiments of the present disclosure, but not all of the embodiments of the present disclosure. It should be understood that the present disclosure is not limited by the example embodiments described here.

In this specification and the drawings, substantially the same or similar steps and elements are denoted by the same or similar reference numerals, and repeated descriptions of these steps and elements will be omitted. Meanwhile, in the description of the present disclosure, the terms “first”, “second”, etc. are only used to distinguish descriptions and cannot be understood as indicating or implying relative importance or ranking.

Unless defined otherwise, all technical and scientific terms used herein have the same meaning as commonly understood by one of ordinary skill in the art to which the present disclosure belongs. The terminology used herein is for the purpose of describing embodiments of the present invention only and is not intended to be limiting of the present invention.

To facilitate description of the present disclosure, concepts related to the present disclosure are introduced below.

Contactor: including coil, static iron core and moving iron core. When the coil is energized, the magnetic field generated by the coil current causes the static iron core to generate electromagnetic force to attract the moving iron core, and the moving iron core moves and attracts the static iron core (also called the attraction of the contactor), thereby connecting the circuit. When the coil is de-energized, the moving iron core returns to its original position, for example by means of a spring.

Attraction voltage: the voltage required for contactor attraction under given operating conditions. This attraction voltage is, for example, specific to the design of the contactor and is predetermined.

Attraction current: the current required to ensure contactor attraction under given operating conditions. This attraction current is, for example, specific to the design of the contactor and is predetermined.

Attraction holding current: the current required to maintain the attraction state after the contactor has successfully attracted. This attraction holding current is, for example, specific to the design of the contactor and is predetermined.

For example, in cases where the actual operating temperature exceeds the normal operating temperature, the contactor suffers from difficulty in attraction or unstable attraction. This is due to the increase in temperature causing the coil resistance to increase, and as a result, the coil current is lower when the same coil voltage is supplied, or a higher voltage is required to achieve the same coil current.

This problem is particularly obvious when the supply voltage of the power supply supplying the contactor is low. There is a certain voltage drop on the circuit from the power supply to the contactor, which is caused by, for example, voltage regulating components (such as high-side drive and low-side drive) used to adjust the power supply voltage to the supply voltage for the contactor. In cases where the supply voltage itself is already low, this voltage drop greatly increases the likelihood that the coil voltage will not meet the attraction voltage. Alternatively, choosing more expensive voltage regulating components can reduce the voltage drop, but this increases the cost.

In addition to the above, another solution includes redesigning the coil, such as reducing the coil resistance by increasing the cross-sectional area of the copper wire of the coil. Alternatively, the moving parts of the contactor may be redesigned to reduce the dynamic repulsion to which they are subjected, thereby reducing the required electromagnetic force and therefore the attraction current.

However, these solutions are costly, require a partial redesign, and have a low degree of flexibility, requiring replacement of the contactors if problems arise after the contactors have been selected based on the circuit requirements and contactor design specifications.

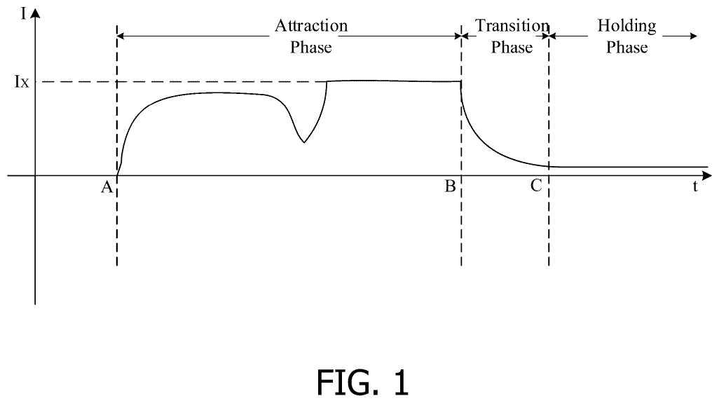

FIG. 1 exemplarily shows a schematic diagram of a current change curve during the attraction process of a contactor according to an embodiment of the present disclosure.

The horizontal axis of the current change curve according to FIG. 1 is time t, and the vertical axis is current I. As shown in FIG. 1, according to an embodiment of the present disclosure, the attraction process of the contactor may include, for example, an attraction phase, a transition phase and a holding phase. For example, the attraction phase indicates a process of the contactor from starting to attract to stable attraction, the transition phase indicates a process of the contactor gradually transitioning from a stable attraction state to a state of maintaining attraction, and the holding phase indicates a process of the contactor to maintain attraction with a low attraction holding current. In this embodiment, the attraction phase is from endpoint A to endpoint B, the transition phase is from endpoint B to endpoint C, and the holding phase starts from endpoint C until the contactor is controlled to turn off.

The contactor is powered by a power supply external to the contactor, for example when the contactor is a contactor arranged on a circuit board, the power supply may be a driving power supply for the circuit board. The power supply voltage of the power supply may be, for example, 19V DC voltage, 24V DC voltage, or the like. A voltage regulating component is also provided, for example, in a circuit including the power supply and the contactor, in order to regulate the power supply voltage to the supply voltage supplied to the contactor. After the contactor is supplied with the supply voltage, a coil voltage at the coil of the contactor is generated.

In the attraction phase, the contactor is provided with a first power supply voltage, for example for a first power supply time. The endpoint A of the attraction phase is, for example, the time point when the coil voltage reaches the attraction voltage, and the endpoint B is, for example, the time point when the first power supply time is reached from the endpoint A.

For simple description, in the embodiment according to the present disclosure, the time point when the contactor is provided with the first power supply voltage and the time point when the coil voltage reaches the attraction voltage are regarded as the same time point. In fact, the two time points may be slightly different, which is not limited by the present disclosure.

At endpoint A, that is, after the coil voltage reaches the attraction voltage, coil current is generated, and the electromagnetic force generated by the coil current causes the moving iron core to move toward the stationary iron core. The coil current increases gradually, and the moving distance of the moving iron core also increases gradually. After the moving iron core moves through the opening distance (that is, the distance between the moving iron core and the static iron core in the disconnected state), it realizes physical contact with the static iron core. Subsequently, an actuator inside the contactor drives the moving iron core to continue to complete the over-travel to achieve reliable engagement of the moving iron core and the static iron core. During this process, the air gap between the moving iron core and the static iron core becomes smaller, resulting in an increase of the inductance of the coil, causing a decrease in the coil current, that is, the current drop.

After the current drops to the lowest point, the moving iron core and the static iron core have achieved reliable engagement, the energy consumed to maintain this engagement decreases, and the coil current increases again until it reaches the attraction current Ix of the contactor. It is known from experience that in order to achieve stable attraction of the contactor, the coil current should be maintained at the level of the attraction current Ix for a certain period of time. The specific length of the period is specific to the settings of the contactor and/or the user. For example, maintaining the coil current at the level of the attraction current Ix within 30 ms is considered as stable attraction of the contactor.

At endpoint B, that is, after the first power supply time is reached, the contactor achieves stable attraction. According to embodiments of the present disclosure, in order to reduce the energy consumption of the contactor, the contactor is transitioned from a stable attraction state to a state of maintaining attraction.

In the transition phase, the contactor is controlled to be not powered. The coil current decays freely until the attraction holding current of the contactor, i.e. the endpoint C.

After the endpoint C, that is, after reaching the attraction holding current, the contactor is powered with a second power supply voltage less than the first power supply voltage, which allows the contactor to remain attracted at a smaller coil current, and reduces the energy consumption while ensuring the normal function of the contactor.

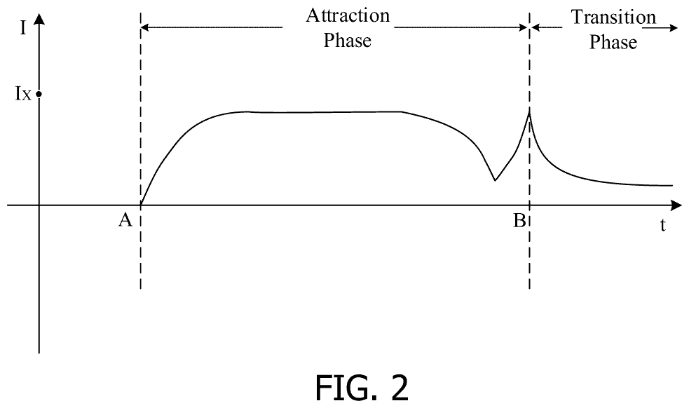

FIG. 2 exemplarily shows a schematic diagram of an abnormal current drop process during an attraction of the contactor.

In a manner similar to FIG. 1, FIG. 2 shows the attraction phase and the transition phase in the attraction process of the contactor, the attraction phase being from endpoint A to endpoint B, and the transition phase starting from endpoint B, the subsequent phases not shown. The endpoint A of the attraction phase is, for example, a time point when the coil voltage reaches the attraction voltage, and the endpoint B is, for example, a time point when the first power supply time is reached from the endpoint A.

As shown in FIG. 2, for example, when the contactor is affected by high temperature or the power supply voltage is low, during the attraction phase, that is, within the preset first power supply time TAB, the coil current of the contactor may not reach the attraction current Ix or the endpoint B of the preset power supply time has been reached before the attraction current Ix is reached, causing the contactor to enter the transition phase and no longer be powered. Alternatively, in an example of an abnormal current drop process not shown, the coil current may reach the attraction current Ix but the remaining power supply time is not long enough to maintain the coil current at the attraction current Ix for a certain period of time, which will also cause unstable attraction of the contactor.

The applicant has found that within the preset first power supply time TAB, the coil current, whether it is unable to reach the attraction current Ix or is able to reach the attraction current Ix but unable to maintain it for a certain period of time, will exhibit an abnormal current drop process that is different from the normal current drop process. That is, during an abnormal current drop, the current drops more slowly. According to the present disclosure, this abnormal current drop process is used to determine in advance that the contactor cannot be stably attracted within a preset power supply time.

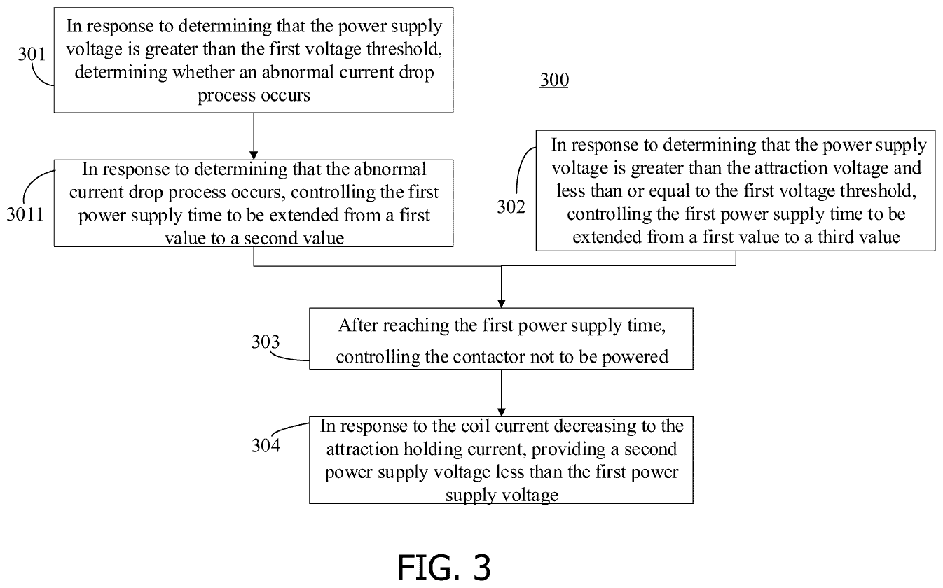

FIG. 3 shows a schematic flow diagram of steps of a method 300 for controlling a contactor according to an embodiment of the present disclosure.

According to embodiments of the present disclosure, for example, the power supply voltage of the power supply used to power the contactor may be compared with the magnitude of the first voltage threshold.

It is considered herein that it is known from experiments or experience that when the contactor used is powered by a power supply voltage less than the first voltage threshold, the contactor cannot be stably attracted with a high probability (for example, 90%, etc.). Preferably, the first voltage threshold is obtained and set through simulation or the like.

As shown in FIG. 3, in step 301, in response to determining that the power supply voltage is greater than the first voltage threshold, for example, it may be determined whether an abnormal current drop process occurs. That is, when the contactor is stably attracted with a high probability, it is determined whether an abnormal current drop process occurs.

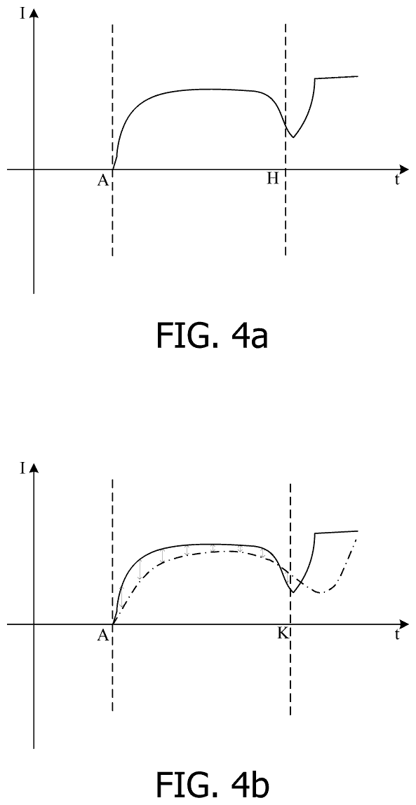

A preferred embodiment of the process of determining whether an abnormal current drop occurs is described with reference to FIGS. 4a and 4b.

Next, in step 3011, in response to determining that the abnormal current drop process occurs, for example, the first power supply time can be controlled to be extended from a preset first value to a second value, and during the first power supply time, the first power supply voltage for the contactor is provided. This abnormal current drop process indicates that the contactor cannot be stably attracted as expected.

According to an embodiment of the present disclosure, in the event of an abnormal current drop process, the first power supply time for providing the first power supply voltage is extended, so that even if the current drop process is long, it is still possible to make the coil current reach the attraction current and maintain at the attraction current for a certain period of time by extending the first power supply time.

The preset first value is derived, for example, from a working process of the contactor in an ideal state according to design specifications. In other words, under normal operating temperature and/or power supply voltage, the first power supply time taking the preset first value can ensure normal and stable attraction of the contactor.

Preferably, the second value is obtained and set by testing in a simulation or the like. By extending the first power supply time to the second value, normal and stable attraction of the contactor can be ensured, for example, even at higher operating temperatures.

Alternatively and/or additionally, in step 302, the first power supply time is controlled to be extended from the first value to a third value in response to determining that the power supply voltage is greater than the attraction voltage and less than or equal to the first voltage threshold.

Preferably, the third value is obtained and set by testing in a simulation or the like. By extending the first power supply time to the third value, normal and stable attraction of the contactor can be ensured, for example, even at higher operating temperatures. The third value can be equal to the second value or greater than the second value.

Exemplarily, the first value may be 80 ms, the second value may be 200 ms, and the third value may be 250 ms, and so on. The specific numerical values are obtained by testing through simulation and other methods, for example, so that the corresponding operation mode can be realized.

It should be understood that within the scope of the present disclosure, a lower supply voltage should also suffice to be greater than the attraction voltage of the contactor. Otherwise the contactor cannot start the attraction process.

If the power supply voltage is less than or equal to the first voltage threshold, it is no longer determined whether an abnormal current drop process occurs during the attraction process of the contactor as described in step 301, but the first power supply time is directly controlled to be extended from the first value to the third value. This is because, according to the embodiment of the present disclosure, the first voltage threshold has been obtained and set by testing, and based on the fact that the power supply voltage is less than or equal to the first voltage threshold, it can be essentially assumed that the contactor is not able to be stably attracted at the preset first value.

Utilizing step 302, the computational cost of determining whether an abnormal current drop process occurs is advantageously reduced.

Next, in step 303, the contactor may be controlled not to be powered, for example. Preferably, the contactor is controlled not to be powered by controlling the voltage regulating means (e.g. by switching off the high-side drive).

In addition, in step 304, for example, in response to the coil current decreasing to the attraction holding current, it may be controlled to provide the contactor with a second power supply voltage less than the first power supply voltage. Under the second power supply voltage, the coil current of the contactor maintains at the attraction holding current, and the contactor maintains stable attraction. In this way, the power consumption of the contactor throughout the stable attraction process is reduced.

The method 300 for controlling a contactor according to an embodiment of the present disclosure determines in advance whether the contactor can be stably attracted under the current power supply voltage by setting a first voltage threshold, and directly controls the extension of the first power supply time when it is determined (with a high probability) that the contactor cannot be stably attracted, reducing subsequent calculation costs; by determining the abnormal current drop process, it is judged in advance that the contactor (with high probability) cannot be stably attracted under the current power supply voltage, and the first power supply time is extended in a timely manner, so that the stable attraction of the contactor is ensured under non-ideal working environments without the need to change the power supply voltage or redesign and replace the contactor, greatly reducing the cost of applying contactors; compared with directly setting the first power supply time to a fixed and longer time period that always satisfies the stable attraction of the contactor, this method flexibly controls the first power supply time, which not only satisfies the stable attraction of the contactor under different working environments, but also realizes lower power consumption; after the contactor is stably attracted, the coil current is controlled to decrease and remain at the attraction holding current, reducing the power consumption of the contactor.

FIGS. 4a and 4b respectively show a schematic diagram of a process of determining an abnormal current drop according to an embodiment of the present disclosure.

In the embodiment shown with reference to FIG. 4a, for example, a first duration T_{AH} may be determined, which is the duration between a first time point A when the coil voltage reaches the attraction voltage and a second time point H when the coil current decreases to the first current threshold. Based on the first duration T_{AH} being greater than the first duration threshold, it can be determined that an abnormal current drop process occurs.

Preferably, the first current threshold may be, for example, a preset percentage of the attraction current, such as 50%, 40%, etc.

Preferably, the first duration threshold is obtained and set by testing in a simulation or other manner, so that when the first duration T_{AH} exceeds the first duration threshold, if the contactor is powered with the preset first value of the first power supply time, the probability that the contactor will not be able to be stably attracted later is high.

In other embodiments, for example, the current change curve within the second duration may be obtained, and the similarity of the current change curve with the reference current change curve may be determined. Based on the similarity being less than the similarity threshold, it is determined that an abnormal current drop process occurs.

The second duration may, for example, start from the first time point A when the coil voltage reaches the attraction voltage and last for a preset time period T_{AK} until the third time point K. Preferably, the preset time period T_{AK} and the similarity threshold are obtained and set by testing in a simulation or other manner. When the similarity of the current change curve with the reference change curve in the preset time period T_{AK} is lower than the similarity threshold, if the contactor is powered with the preset first value of the first power supply time, the probability that the contactor will not be able to be stably attracted later is high.

Preferably, the preset time period T_{AK} ends before the lowest point of the current drop process of the reference current change curve. In this way, not only does it ensure a high degree of accuracy in similarity determination based on the relatively complete current drop curve of the reference current change curve, but it also enables timely adjustment of the first power supply time.

According to embodiments of the present disclosure, for example, the similarity may be determined based on the Euclidean distances and/or Manhattan distances and/or mean absolute error between the current change curve and the reference current change curve within the second duration and/or using deep learning or other methods.

For example, in the case where the similarity is determined based on Euclidean distances and/or Manhattan distances and/or mean absolute error, preferably, the current change curve of the coil when the contactor is powered in an ideal working state is obtained in a simulation manner as a reference current change curve.

For example, when the similarity is determined based on deep learning or other methods, it is preferable to collect the current change curves of the coils of a plurality of normally attracted contactors as a training data set, and perform deep learning model training based on the training data set to obtain the reference current change curve.

An embodiment of determining similarity based on Euclidean distances is shown with reference to FIG. 4b. As shown in FIG. 4b, the Euclidean distances between the actual current change curve (shown by a dotted line) and the reference current change curve (shown by a solid line) of the coil of the contactor during the second duration are accumulated., and the similarity of the current change curve with the reference current change curve is determined on this basis.

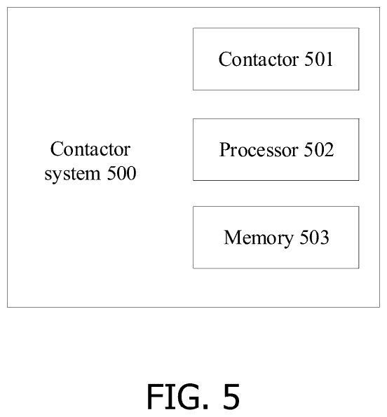

FIG. 5 shows a schematic diagram of a contactor system 500 in accordance with an embodiment of the present disclosure.

As shown in FIG. 5, a contactor system 500 according to an embodiment of the present disclosure may include, for example, a contactor 501, one or more processors 502, and one or more memories 503.

Computer-executable programs are stored in the one or more memories 503. When the computer-executable programs are executed by the processor 502, the method for controlling a contactor according to one of the embodiments of the present disclosure is performed.

Contactor system 500 may be, for example, a circuit board including the contactor. The contactor system 500 according to the embodiment of the present disclosure determines in advance whether the contactor can be stably attracted under the current power supply voltage by setting a first voltage threshold, and directly controls the extension of the first power supply time when it is determined (with a high probability) that the contactor cannot be stably attracted, reducing subsequent calculation costs; by determining the abnormal current drop process, it is judged in advance that the contactor (with high probability) cannot be stably attracted under the current power supply voltage, and the first power supply time is extended in a timely manner, so that the stable attraction of the contactor is ensured under non-ideal working environments without the need to change the power supply voltage or redesign and replace the contactor, greatly reducing the cost of applying contactors; compared with directly setting the first power supply time to a fixed and longer time period that always satisfies the stable attraction of the contactor, this method flexibly controls the first power supply time, which not only satisfies the stable attraction of the contactor under different working environments, but also realizes lower power consumption; after the contactor is stably attracted, the coil current is controlled to decrease and remain at the attraction holding current, reducing the power consumption of the contactor.

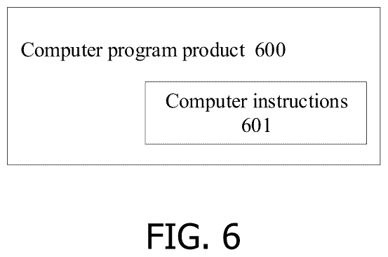

FIG. 6 shows a schematic view of a computer program product 600 according to an embodiment of the present disclosure.

As shown in FIG. 6, the computer program product 600 may include computer instructions 601. The computer instructions 601 may be used to implement the method according to one of the embodiments of the present disclosure when executed by a processor.

The computer program product 600 according to the embodiment of the present disclosure determines in advance whether the contactor can be stably attracted under the current power supply voltage by setting a first voltage threshold, and directly controls the extension of the first power supply time when it is determined (with a high probability) that the contactor cannot be stably attracted, reducing subsequent calculation costs; by determining the abnormal current drop process, it is judged in advance that the contactor (with high probability) cannot be stably attracted under the current power supply voltage, and the first power supply time is extended in a timely manner, so that the stable attraction of the contactor is ensured under non-ideal working environments without the need to change the power supply voltage or redesign and replace the contactor, greatly reducing the cost of applying contactors; compared with directly setting the first power supply time to a fixed and longer time period that always satisfies the stable attraction of the contactor, this method flexibly controls the first power supply time, which not only satisfies the stable attraction of the contactor under different working environments, but also realizes lower power consumption; after the contactor is stably attracted, the coil current is controlled to decrease and remain at the attraction holding current, reducing the power consumption of the contactor.

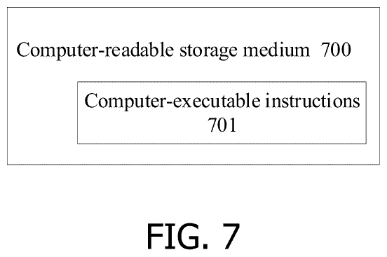

FIG. 7 shows a schematic diagram of a computer-readable storage medium 700 according to an embodiment of the present disclosure.

As shown in FIG. 7, computer-executable instructions 701 may be stored on the computer-readable storage medium 700. The computer-executable instructions 701 may be used to implement the method according to one of the embodiments of the present disclosure when executed by a processor.

The computer-readable storage medium 700 according to embodiments of the present disclosure determines in advance whether the contactor can be stably attracted under the current power supply voltage by setting a first voltage threshold, and directly controls the extension of the first power supply time when it is determined (with a high probability) that the contactor cannot be stably attracted, reducing subsequent calculation costs; by determining the abnormal current drop process, it is judged in advance that the contactor (with high probability) cannot be stably attracted under the current power supply voltage, and the first power supply time is extended in a timely manner, so that the stable attraction of the contactor is ensured under non-ideal working environments without the need to change the power supply voltage or redesign and replace the contactor, greatly reducing the cost of applying contactors; compared with directly setting the first power supply time to a fixed and longer time period that always satisfies the stable attraction of the contactor, this method flexibly controls the first power supply time, which not only satisfies the stable attraction of the contactor under different working environments, but also realizes lower power consumption; after the contactor is stably attracted, the coil current is controlled to decrease and remain at the attraction holding current, reducing the power consumption of the contactor.

The computer-readable storage medium according to embodiments of the present disclosure may be volatile memory or non-volatile memory, or may include both volatile and non-volatile memory. The non-volatile memory may be read-only memory (ROM), programmable read-only memory (PROM), erasable programmable read-only memory (EPROM), electrically erasable programmable read-only memory (EEPROM) or flash memory. Volatile memory can be random access memory (RAM), which acts as external cache memory. By way of illustration and not limitation, many forms of RAM are available such as static random access memory (SRAM), dynamic random access memory (DRAM), synchronous dynamic random access memory (SDRAM), double data rate synchronous dynamic random access memory (DDRSDRAM), enhanced synchronous dynamic random access memory (ESDRAM), synchronous link dynamic random access memory (SLDRAM), and direct rambus random access memory (DR RAM). It should be noted that the memory of the methods described herein is intended to comprise, without being limited to, these and any other suitable types of memory. It should be noted that the memory of the methods described herein is intended to comprise, without being limited to, these and any other suitable types of memory.

It should be noted that the flowcharts and block diagrams in the accompanying drawings illustrate the architecture, functions and operations of possible implementations of systems, methods and computer program products according to various embodiments of the present disclosure. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or operations, or combinations of special purpose hardware and computer instructions.

Generally speaking, various example embodiments of the present disclosure may be implemented in hardware or special purpose circuits, software, firmware, logic, or any combination thereof. Some aspects may be implemented in hardware, while other aspects may be implemented in firmware or software which may be executed by a controller, microprocessor or other computing device. While aspects of embodiments of the disclosure are illustrated or described as block diagrams, flow charts, or using some other pictorial representation, it will be understood that the blocks, apparatus, systems, techniques or methods described herein may be implemented, as non-limiting examples, in hardware, software, firmware, special purpose circuits or logic, general purpose hardware or controller or other computing devices, or some combination thereof.

The example embodiments of the present disclosure described in detail above are illustrative only and not restrictive. It will be understood by those skilled in the art that various modifications and combinations can be made to these embodiments or features thereof without departing from the principles and spirit of the present disclosure, and such modifications should fall within the scope of the present disclosure.

1. A method for controlling a contactor, wherein the contactor is powered by a power supply external to the contactor, the method comprising:
in response to determining that a power supply voltage of the power supply is greater than a first voltage threshold, determining whether an abnormal current drop process occurs; and
in response to determining that the abnormal current drop process occurs, controlling a first power supply time, during which a first power supply voltage for the contactor is supplied, to be extended from a preset first value to a second value,
wherein the abnormal current drop process indicates that the contactor fails to attract as expected.

2. The method of claim 1, further comprising:
controlling the first power supply time to be extended from the first value to a third value in response to determining that the power supply voltage is greater than an attraction voltage and less than or equal to the first voltage threshold.

3. The method of claim 1, wherein the determining whether the abnormal current drop occurs comprises:
determining a first duration, the first duration being a duration between a first time point when a coil voltage of a coil of the contactor reaches the attraction voltage and a second time point when a coil current of the coil of the contactor decreases to a first current threshold, wherein
the abnormal current drop is determined to occur based on the first duration being greater than a first duration threshold.

4. The method of claim 3, wherein
the first current threshold is a preset percentage of an attraction current of the contactor.

5. The method of claim 1, the determining whether the abnormal current drop process occurs comprises:
determining a similarity of the current change curve with a reference current change curve in a second duration; and
determining that the abnormal current drop process occurs based on the similarity being less than a similarity threshold.

6. The method of claim 5, wherein the similarity is determined based on Euclidean distances and/or Manhattan distances and/or a mean absolute error between the current change curve and the reference current change curve in the second duration and/or using a deep learning approach.

7. The method of claim 1, further comprising:
after reaching the first power supply time, controlling the contactor not to be powered; and
in response to a coil current of a coil of the contactor decreasing to an attraction holding current, controlling to provide a second power supply voltage smaller than the first power supply voltage for the contactor.

8. A contactor system comprising:
a contactor;
one or more processors; and
one or more memories having stored therein computer-executable programs that, when executed by the one or more processors, cause the one or more processors to:
determine whether an abnormal current drop process occurs in response to determining that a power supply voltage of a power supply external to the contactor is greater than a first voltage threshold; and
control a first power supply time, during which a first power supply voltage for the contactor is supplied, to be extended from a preset first value to a second value in response to determining that the abnormal current drop process occurs,
wherein the abnormal current drop process indicates that the contactor fails to attract as expected.

9. A computer program product comprising computer instructions, which when executed by a processor, cause the processor to:
determine whether an abnormal current drop process occurs in response to determining that a power supply voltage of a power supply external to a contactor is greater than a first voltage threshold; and
control a first power supply time, during which a first power supply voltage for the contactor is supplied, to be extended from a preset first value to a second value in response to determining that the abnormal current drop process occurs,
wherein the abnormal current drop process indicates that the contactor fails to attract as expected.

10. The contactor system of claim 8, wherein the computer-executable programs, when executed by the one or more processors, further cause the one or more processors to:
control the first power supply time to be extended from the first value to a third value in response to determining that the power supply voltage is greater than an attraction voltage and less than or equal to the first voltage threshold.

11. The contactor system of claim 8, wherein determining whether the abnormal current drop occurs comprises:
determining a first duration between a first time point when a coil voltage of a coil of the contactor reaches an attraction voltage and a second time point when a coil current of the coil decreases to a first current threshold; and
determining that the abnormal current drop occurs based on the first duration being greater than a first duration threshold.

12. The contactor system of claim 11, wherein the first current threshold is a preset percentage of an attraction current of the contactor.

13. The contactor system of claim 8, wherein determining whether the abnormal current drop process occurs comprises:
determining a similarity of a current change curve with a reference current change curve in a second duration; and
determining that the abnormal current drop process occurs based on the similarity being less than a similarity threshold.

14. The contactor system of claim 13, wherein the similarity is determined based on at least one of: Euclidean distances, Manhattan distances, a mean absolute error between the current change curve and the reference current change curve in the second duration, or a deep learning approach.

15. The contactor system of claim 8, wherein the computer-executable programs, when executed by the one or more processors, further cause the one or more processors to:
control the contactor not to be powered after reaching the first power supply time; and
control to provide a second power supply voltage smaller than the first power supply voltage for the contactor in response to a coil current of a coil of the contactor decreasing to an attraction holding current.

16. The computer program product of claim 9, wherein the computer instructions, when executed by the processor, further cause the processor to:
control the first power supply time to be extended from the first value to a third value in response to determining that the power supply voltage is greater than an attraction voltage and less than or equal to the first voltage threshold.

17. The computer program product of claim 9, wherein determining whether the abnormal current drop occurs comprises:
determining a first duration between a first time point when a coil voltage of a coil of the contactor reaches an attraction voltage and a second time point when a coil current of the coil decreases to a first current threshold; and
determining that the abnormal current drop occurs based on the first duration being greater than a first duration threshold.

18. The computer program product of claim 17, wherein the first current threshold is a preset percentage of an attraction current of the contactor.

19. The computer program product of claim 9, wherein determining whether the abnormal current drop process occurs comprises:
determining a similarity of a current change curve with a reference current change curve in a second duration; and
determining that the abnormal current drop process occurs based on the similarity being less than a similarity threshold.

20. The computer program product of claim 19, wherein the similarity is determined based on at least one of: Euclidean distances, Manhattan distances, a mean absolute error between the current change curve and the reference current change curve in the second duration, or a deep learning approach.
